(19) United States
(12) Patent Application Publication
(10) Pub. No.: US 2004/0082371 A1
(43) Pub. Date: Apr. 29, 2004

(54) Display apparatus

(76) Inventor: Fausto Terlizzi, Ascot Vale (AU)

Correspondence Address: JAMES C. EAVES JR., GREENEBAUM DOLL & MCDONALD PLLC, 3500 NATIONAL CITY TOWER, 101 SOUTH FIFTH STREET, LOUISVILLE, KY, 40202, US

(21) Appl. No.: 10/465,956

(22) PCT Filed: Dec. 28, 2001
(86) PCT No.: PCT/AU01/01678

(30) Foreign Application Priority Data
Dec. 29, 2000 (AU) PR 2353

(51) Int. Cl. A63F 13/00

(52) U.S. Cl. 463/11

(57) ABSTRACT

Apparatus (1) for entering and displaying data relating to a participatory event and for use by one or more participants. The apparatus (1) includes electronic data entry means (3) for use by each participant to enter data at a time when each participant is to participate in the event and electronic processing means for receiving and processing the data entered by each participant There is also included display means (5) for displaying the data processed by the electronic processing means.

### FIELD OF THE INVENTION

This invention relates to apparatus for entering and displaying data. It has particular, although not exclusive, application to apparatus for use in games and pastimes, such as card games.

### BACKGROUND TO THE INVENTION

In many card games, such as the game of Bridge, the rules of the game may require a player to make a bid, or an offer to other players. Whilst this of course be done verbally, in many instances, it would be desirable if the bid or offer could be made silently, or on a confidential basis so that other players are not disturbed by the bidding process, or so as to maintain confidentiality of the, bidding process, until all bids have been submitted. Some individuals may however, have a physical impairment, such as a speech defect or trembling hands, in the case of bids which must be submitted in writing, which effectively prevents or inhibits them from participating fully in playing such games. Yet other problems also manifest themselves during the bidding process, as would be familiar to players of card games. For example, where written bids are to be submitted, it is possible for some players, on occasion, to be tempted to cheat by writing different sign bids on a slip or piece of paper. Even where a player plays fairly, in those situations where bids are required to be handwritten, often a player's handwriting may not be particularly legible, or the particular suit that is being bid may not be represented clearly. Quite apart from these issues, once a bid has been submitted, occasionally, players are tempted to (and in fact) change their bids after having submitted them. This can cause significant disruption to the game itself, and on occasion, can result in disputes or conflict between players who become annoyed by attempts by another player (or players) to change bids previously submitted, when it would be considered inappropriate to do so.

The present invention aims to alleviate one or more of the prior art problems discussed above.

### SUMMARY OF THE INVENTION

Accordingly, the present invention provides:

an apparatus for entering and displaying data relating to a participatory event and for use by one or more participants, said apparatus comprising:

electronic data entry means for use by each participant in said one or more participants to enter data at a time when said each participant is to participate in said event;

electronic processing means for receiving and processing said data entered by said each participant; and

display means for displaying the data processed by said electronic processing means.

Preferably, the event or activity is a game or a sport. Particularly preferred sports are card games, such as Bridge, Poker, the game known as “500”, and the like.

It is also preferred that the apparatus is electronic, or apparatus which contains electronic components. It is particularly preferred that the apparatus includes a computer or computerised elements.

Preferably, the data entry means takes the form of a key pad which comprises a plurality of keys, where each key is associated with an entry of an individual item of data. For example, the keypad could comprise keys which code for a particular character, letter of the alphabet, symbol or numeral (or combinations of two or more of these). Where the apparatus is to be used for playing card games, typically, the data entry means would comprise a keypad containing a plurality of keys, the keys containing the symbols associated with individual card suits, and numbers or symbols to identify the individual cards within each suit.

Where two or more players are involved in playing a game (such as a card game) the apparatus could comprise more than one data entry means, in which case, each individual player would have his or her own individual data entry device (such as an individualised keypad for each player). Preferably, the data entry means would be linked by suitable means to the display means, so that upon entering data on the data entry means, the data so entered is transferred and displayed on the display means. Preferred examples of the linkage/transfer means would include computer cables and other electronic cables for linking electronic apparatus.

The display means is preferably an electronic device which is capable of displaying data entered via the data entry means. Typically, the display means would take the form of a computer screen, a television screen or a like electronic apparatus. The display means could be integrally formed with one or more units of the data entry means, or alternatively, it could be physically separate from one or more units of the data entry means. In the latter case, for example, the display means could take the form of a screen for displaying bids, scores or other information to an audience viewing play during a card game.

The display means could also take the form of a display which is televised or broadcast to locations remote from where that game is being played (such as via a television broadcast, over the Internet, or via other wireless means of the kind readily appreciated by those of ordinary skill in the art).

### BRIEF DESCRIPTION OF THE DRAWINGS

Preferred embodiments of the present invention will now be described by way of example only, with reference to the accompanying drawings, in which:

FIG. 1 represents a plan view of a first embodiment of an apparatus made in accordance with the present invention;

FIG. 2 represents a plan view of a form of a data entry means for use in connection with the present invention;

FIG. 3 represents a plan view of a second embodiment of apparatus made in accordance with the present invention; and

FIG. 4 is an alternative form of data entry means incorporating a display means.

### DETAILED DESCRIPTION OF PREFERRED EMBODIMENTS OF THE INVENTION

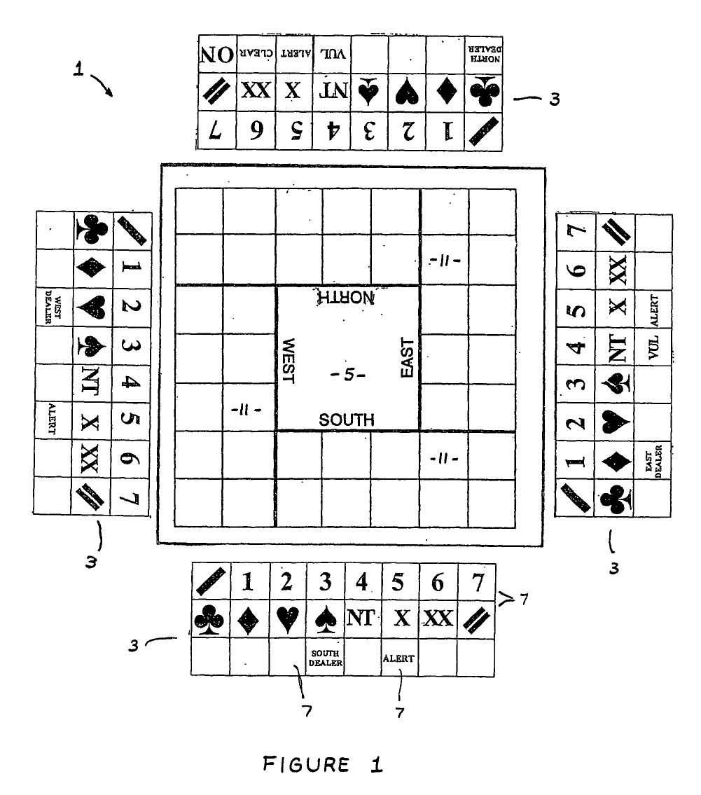

Referring now to the drawings, FIG. 1 represents a gaming apparatus (generally denoted as 1), constructed in accordance with the present invention. As will be apparent from FIG. 1, apparatus 1 is a gaming apparatus for use in association with a card game (such as Bridge, Poker, 500 or the like). The apparatus 1 takes the form of four data entry units, each denoted by numeral 3 together with a display means 5.

Each of the data entry units 3 takes the form of a keypad, containing a number of keys 7. As can be seen, individual keys can be activated by pressing them, so as to code for the entry of particular information (such as for example, a number or a character). As can be seen from FIG. 1 each of the keys 7 codes, when activated (such as for example, by pressing the key), for either a number, or a character (such as a card suit). In particularly preferred embodiments of the invention, the keypad could be made so that the keys 7 are touch sensitive, or are sensitive to some other activation stimulus (such as for example, temperature). Preferably, and particularly where a player suffers from a physical impairment (such as trembling hands), the keys would be sensitive to minimal stimuli (eg, to very small pressures) in order to activate them. In yet further embodiments of the invention, rather than the data entry means taking the form of a keypad, voice activation means could be used in order to submit a bid. Voice activation would be particularly suitable for handicapped persons who are unable to move their arms or hands in order to activate even a touch-sensitive keypad or the like.

Irrespective of the form which the data entry means take (ie whether they take the form a keyboard, keypad or a voice activated or other device), data entered by the data entry means is submitted, following entry, to a display means, for display.

The data entered is transferred from the data entry means (in whatever form that means takes) to the display means used in the particular form of the apparatus. The transfer is achieved via a suitable linkage/transfer means. Typical examples of such means would include the following:

1. electronic cables (and particularly cables suitable for data transfer in computers or computer related equipment);

2. wireless means, such as transfer via infra-red radiation, microwaves, radio waves, or other forms of electromagnetic radiation; and

3. transfer via the Internet.

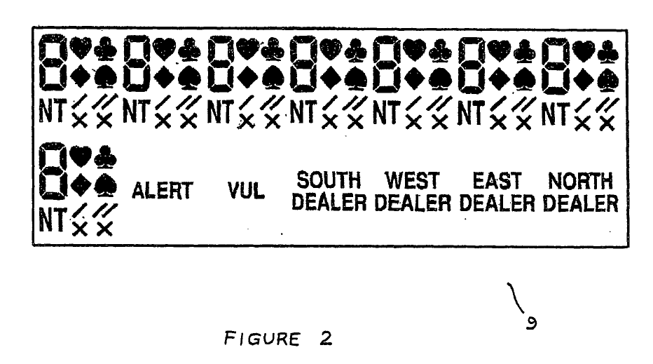

Typically, the data would be submitted via one or other such linkage/transfer means, to a central processing unit, which would process the data, so as to create particular displays on the display means. In the apparatus depicted in FIG. 1, each keypad 3 could thus submit data to a central processing unit (not shown in the drawings) which would manipulate or convert the data in order to provide the desired displays of information on the display device 5. Alternatively or further, each data entry means (such as the keypads 3 shown in the accompanying drawings) could itself contain a central processing unit or computer to process or assist in processing the data, before submitting it to the display. In this respect, FIG. 2 depicts an alternative embodiment of a data entry means, in which processing means (not shown) are provided in the data entry unit itself, so as to provide a digital read-out on each unit of the data entry means (such as the digital keypad 9, depicted in FIG. 2).

In the embodiment of the invention depicted in FIG. 1, the display 5 comprises a plurality of cells 11, each of which is intended to display individual data about each of the four players playing the game in the version of the apparatus shown in that drawing. Persons of ordinary skill in the art would understand however, that the content of the display means that in any particular form of the invention will depend on the nature of the data desired to be displayed, and this in turn, may also depend upon the data processing means (including any software) used in particular in embodiments, to display the desired information. Such persons would also readily understand that in addition to displaying information relating to bids submitted by individual players or by teams of players, a display means for use in connection with the present invention could display many other kinds of data (such as for example, progress scores in a game or match, team information, or any other desired information, for that matter).

In the embodiment shown in FIG. 1, the apparatus 1 is shown as comprising separately, the display 5, and the individual data entry means 3, in the form of the four separate keypads depicted. In other embodiments of the invention however, the display means 5 and data entry means 3 could be formed integrally. In the embodiment of the invention depicted in FIG. 1, the display 5 is shown as a display which might be laid flat on a horizontal surface (such as a table at which a card game might be played), so that players would be able to view rival bids from where they were sitting. In yet further embodiments of the invention however, the display might (for example) comprise an upright display (such as a television screen, computer screen or other form of suitable display for use in the invention), so that not only the players, but also third parties (such as an audience) could view bids submitted, the progress of a game, progress scores, final scores or other desired information.

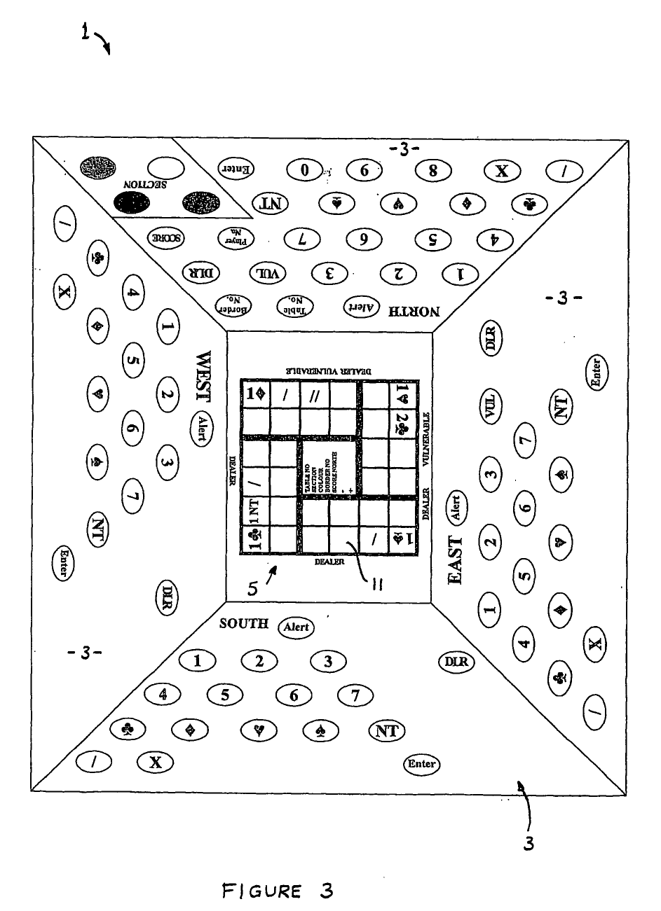

Shown in FIG. 3 is a further embodiment of the apparatus 1 showing each individual data entry means 3 formed integrally with the display means 5 as a single unit.

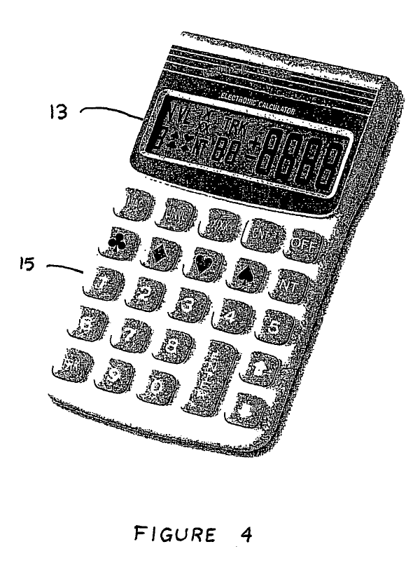

Shown in FIG. 4 is a further alternative embodiment of a data entry means which includes processing means (not shown) and also a digital read-out display unit 13 together with a key pad 15 for data entry by a participant.

In yet further embodiments of the present invention, the display means could take the form of a means for televising, broadcasting or transmitting bid, score or game data not only so that the players themselves or an audience in the immediate physical vicinity of the players could view it, but also so that persons located at a remote location could follow the progress of the game and the conduct of the players. For example, in a yet alternative embodiment of the invention, the players could enter data on their keypad for transmission to a computerised processing unit or a display, where the display would be broadcast via television, the Internet or via a similar means, so that audiences located anywhere in the world could watch the progress of a sporting competition (such as a card game), in accordance with the use of the present invention.

Although the embodiments of the present invention have been described specifically with reference to card games, those of ordinary skill in the art will readily appreciate that the invention is by no means limited to such uses. Person of ordinary skill in the art would readily understand that the invention could be applied to many other uses, and could take many other constructional forms, beyond those described in the preferred embodiments referred to in this specification. Accordingly, persons of ordinary skill in the art would readily appreciate that these, and other modifications or variations are embraced within the spirit and scope of the present invention, which extends to every novel feature and combination of features described in this specification and the accompanying drawings.

1. Apparatus for entering and displaying data relating to a participatory event and for use by one or more participants, said apparatus comprising:
electronic data entry means for use by each participant in said one or more participants to enter data at a time when said each participant is to participate in said event;
electronic processing means for receiving and processing said data entered by said each participant; and
display means for displaying the data processed by said electronic processing means.

2. Apparatus according to claim 1 wherein said data entry means comprises separate data entry devices, one for each participant in said participatory event.

3. Apparatus according to claim 2 wherein said data entry means is a keypad or keyboard.

4. Apparatus according to claim 3 wherein said keypad or keyboard has a plurality of keys, each key of said plurality of keys associated with individual data.

5. Apparatus according to claim 4 wherein said individual data represents any one or combination of a character, letter, symbol or numeral.

6. Apparatus according to any one of claims 2 to 5 wherein said display means is integrally formed with one or more of said separate data entry devices.

7. Apparatus according to any one of claims 1 to 4 wherein said display means is physically separate from said data entry means.

8. Apparatus according to claim 7 wherein said display means is in the form of a screen for displaying to an audience information about each said participant relevant to said event.

9. Apparatus according to claim 7 wherein said display means is a television or like screen such that said event is broadcast to an audience remote from the location of said event.

10. Apparatus according to any one of the previous claims, wherein the data processed by said electronic processing means is transmitted wirelessly to said display means.

11. Apparatus according to any one of the previous claims, wherein the data processed by said electronic processing means is transmitted to said display means by a communications network.

12. Apparatus according to claim 11 wherein said communications network is the Internet.

13. Apparatus according to claim 12 wherein said data entered by said each participant is transmitted over the Internet to said electronic processing means and thereafter transmitted to said display means over the Internet.

14. Apparatus according to any one of the previous claims wherein said data entry means contains said electronic processing means for processing entered data and transmitting the processed data to said display means.

15. Apparatus according to claim 4 wherein said plurality of keys of said key pad or keyboard are touch sensitive.

16. Apparatus according to claim 4 wherein said plurality of keys of said key pad or keyboard are sensitive to activation stimuli, such as temperature.

17. Apparatus according to claim 1 or claim 2 wherein said data entry means is a voice activation means wherein voice commands are used to represent data entered for a certain action to be performed on behalf of a participant in said one or more participants.

18. Apparatus according to any one of the previous claims wherein said participatory event is a sport.

19. Apparatus according to any one of the previous claims wherein said participatory event is a game.

20. Apparatus according to claim 19 wherein said game is a card game.

21. Apparatus according to claim 20 wherein said data entry means comprises a key pad containing a plurality of keys, wherein some or all of the keys contain symbols associated with individual card suits.

22. Apparatus according to claim 21 wherein some of the keys of said plurality of keys identify numbers or symbols used to represent individual cards within each card suit.
